(19) United States
(12) Patent Application Publication
(10) Pub. No.: US 2018/0263214 A1
(43) Pub. Date: Sep. 20, 2018

(54) PET TRAINING DEVICE

(71) Applicant: ANIMAL EXPERT, LLC, Agoura Hills, CA (US)

(72) Inventors: Brandon Parrish MCMILLAN, Los Angeles, CA (US); Jack RENFORTH, Azle, TX (US); Nicholas BAKER, Fort Worth, TX (US)

(21) Appl. No.: 15/909,333

(22) Filed: Mar. 1, 2018

Related U.S. Application Data
(60) Provisional application No. 62/473,642, filed on Mar. 20, 2017.

(51) Int. Cl. A01K 15/02

(52) U.S. Cl. CPC A01K 15/02

(57) ABSTRACT

A pet training device includes a hollow tubular body and a plurality of rigid or semi rigid elements. The hollow tubular body has a first end portion, a second end portion and central portion. The central portion has a diameter that is less than a diameter of both the first and second end portions. At least the first end portion is made from a first material, and at least the second end portion is made from a second material, the first and second materials being different from each other. The plurality of rigid or semi rigid elements are disposed within the hollow tubular body and are capable of being moved to into the first end portion to strike the first material and cause a first sound and moved into the second end portion to strike the second material and cause a second sound different from the first sound.

### CROSS REFERENCE TO RELATED APPLICATIONS

This application claims priority to U.S. Provisional Application No. 62/473,642, filed Mar. 20, 2017, the contents of which are hereby incorporated herein by reference.

### FIELD OF THE INVENTION

The present invention relates to a pet training device. In particular, the present invention relates to a pet training device that is capable of making a variety of sounds.

### DESCRIPTION OF RELATED ART

Conventional pet training devices can include shaker cans. A shaker can or jar is a tool to indicate unwanted pet behavior. Conventional shaker cans can include a metal can that includes a few nails, beans, coins, or pebbles inside the can. The top opening is sealed, for example with tape or some other adhesive. When the pet exhibits unwanted behavior, the can is shaken to indicate such behavior is unwanted to undesired. The can be gently shaken to make minimal noise or shaken harder to make more noise.

### SUMMARY

It has been discovered that a more effective pet training device can include different sounds that enable the pet handler to communicate different messages to the pet. A pet training device according to one embodiment includes a hollow tubular body. The hollow tubular body has a first end portion, a second end portion and central portion. The central portion has a diameter that is less than a diameter of both the first and second end portions. At least the first end portion is made from a first material, and at least the second end portion is made from a second material, the first and second materials being different from each other. A plurality of rigid or semi rigid elements are disposed within the hollow tubular body and are capable of being moved to into the first end portion to strike the first material and cause a first sound and moved into the second end portion to strike the second material and cause a second sound different from the first sound.

### BRIEF DESCRIPTION OF THE DRAWINGS

Referring now to the attached drawings which form a part of this original disclosure:

FIG. 1 is a top perspective view of one embodiment of a pet training device according to the present invention;

FIG. 2 is a top perspective view of the pet training device of FIG. 1 inverted with noise making elements disposed therein;

FIG. 3 is a side elevational view of the pet training device of FIG. 1;

FIG. 4 is a top view of the pet training device of FIG. 1;

FIG. 5 is a bottom view of the pet training device of FIG. 1;

FIG. 6 is a cross sectional view of the pet training device of FIG. 1;

FIG. 7 is an exploded top perspective view of the pet training device of FIG. 1;

FIG. 8 is a top perspective view of another embodiment of a pet training device according to the present invention;

FIG. 9 is a side elevational view of the pet training device of FIG. 8;

FIG. 10 is a top perspective view of another embodiment of a pet training device according to the present invention; and

FIG. 11 is a side elevational view of the pet training device of FIG. 10.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

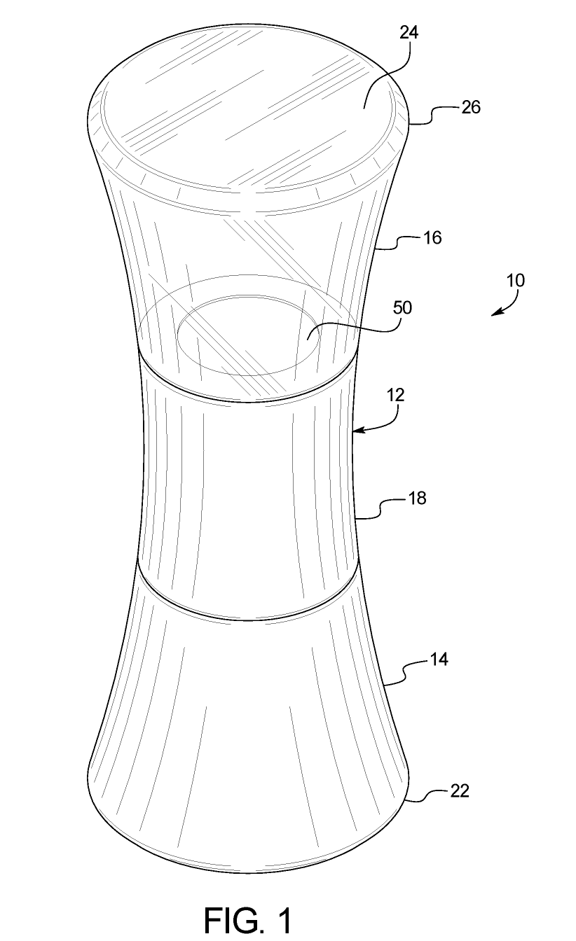

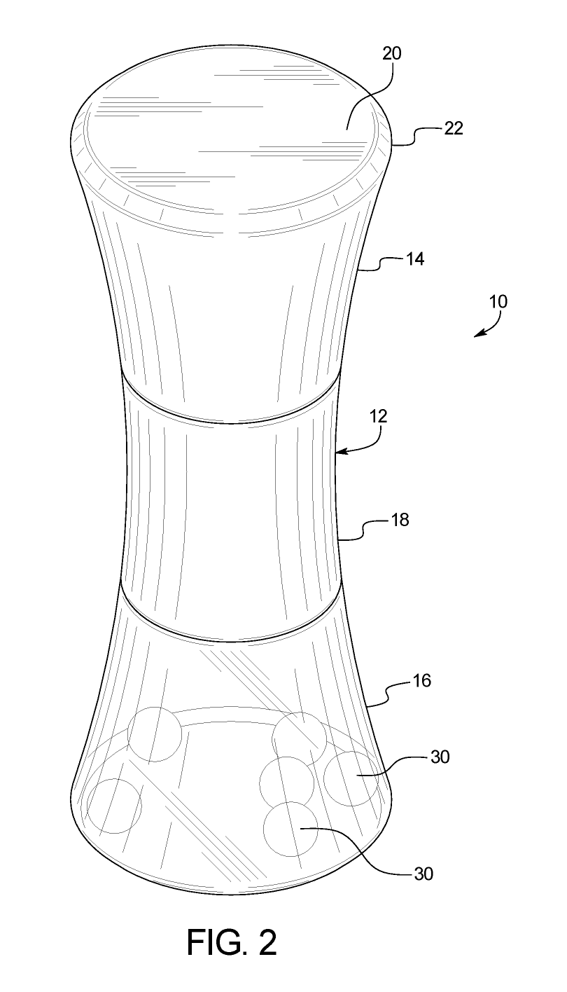

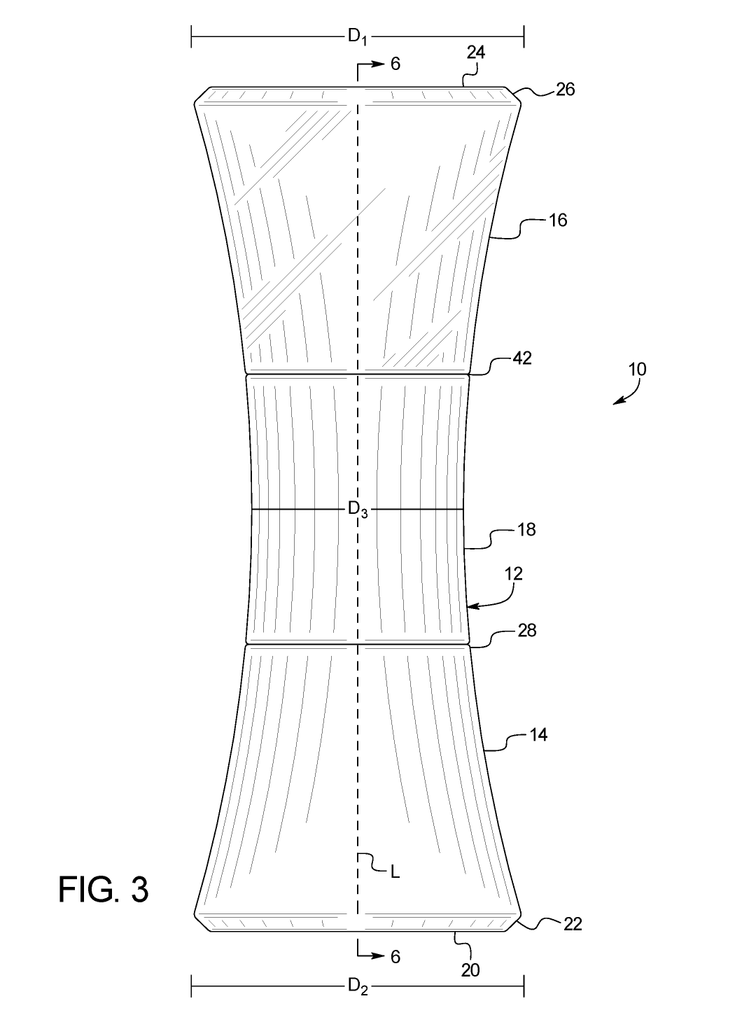

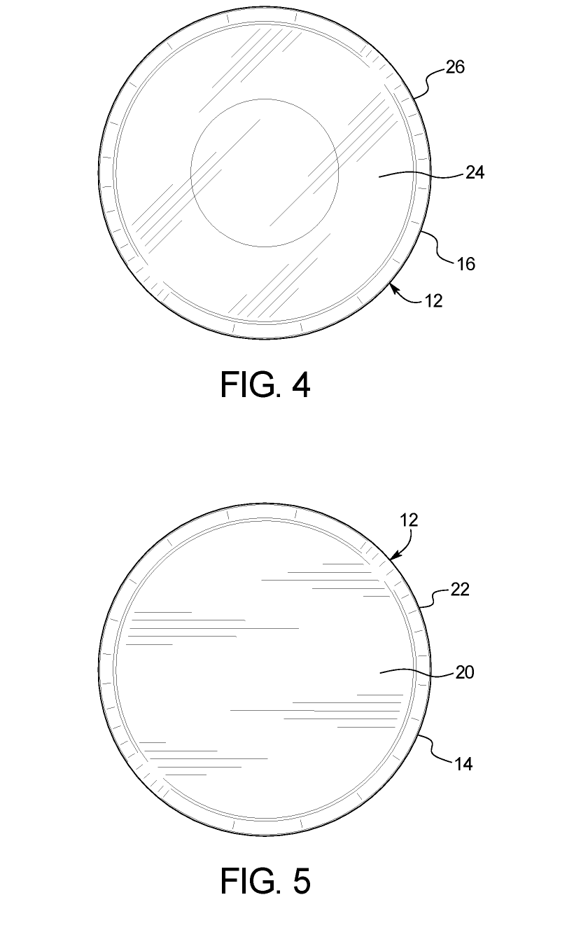

Referring initially to FIGS. 1-7, a pet training device 10 is shown. The pet training device 10 includes a body 12 having a first end portion 14, a second end portion 16 and a central portion 18. The body 12 can be a hollow tubular body with a first end surface 20 at the first end 22 and a second end surface 24 at the second end 26. The hollow tubular body 12 can have an hour glass shape, such that at the first end 22 has a first diameter D₁, the second end 26 has a second diameter D₂ and the middle of the central portion 18 has a third (or central) diameter D₃. The diameter of the body 12 is preferably at its largest diameter (D₁) at the first end 22 and decreases in an arcuate manner along the longitudinal direction L from the first end 22 toward the central portion 18. At the general center (middle) of the hollow tubular body 12 (at the central portion 18), the diameter is preferably at the smallest dimension (D₃). The diameter, from the general center of the hollow tubular body 12 along the longitudinal direction L toward the second end 26 increases in an arcuate manner until the end of the second end portion 16, at a second diameter D₂. The second diameter D₂ can be same diameter as the first diameter D₁. Thus, in one embodiment, the central portion 18 has a diameter D₃ that is less than the diameter D₁ and D₂ of both the first and second ends 22 and 26. However, it is noted that the diameters are merely exemplary and the diameters and shape of the hollow tubular body 12 member can be any desired shape or configuration.

The first end portion 14 can be made from a first material, for example metal or steel. The first end portion 14 can be formed so as to be generally frusto-conical. In particular, the first end 22 of the first end portion 14 is generally circular such that the first end surface 20 is generally circular and flat. The diameter D₁ of the first end portion 14 decreases in a curved or arcuate manner to the second end 28 of the first end portion 14. The second end 28 of the first end portion 14 preferably has the smallest diameter of the first end portion 14. The second end 28 is generally circular. It is noted that the first end portion 14 can be formed in any desired manner and the structure described herein is merely exemplary.

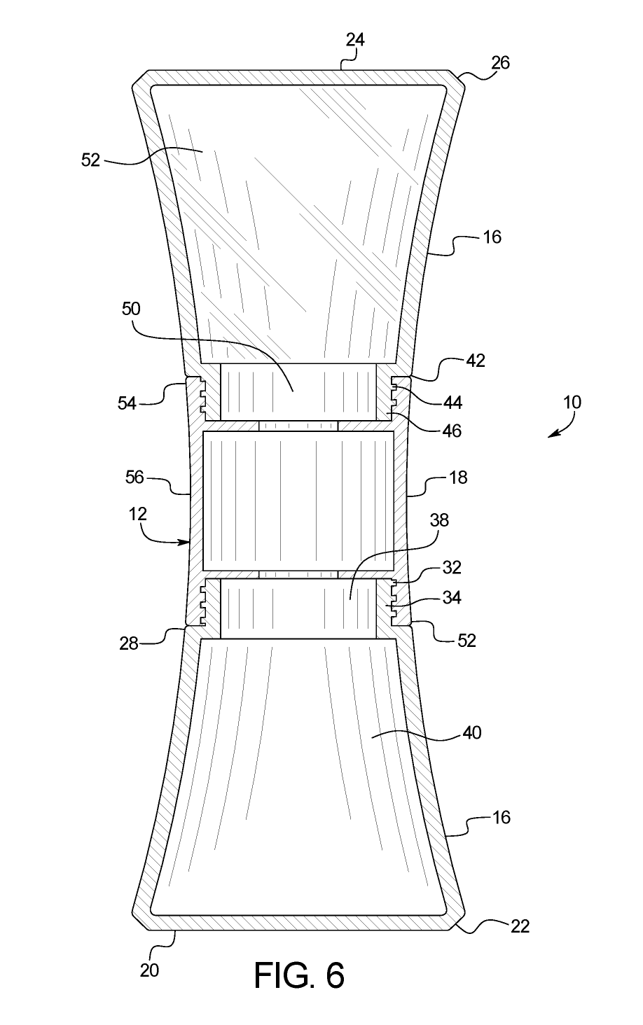

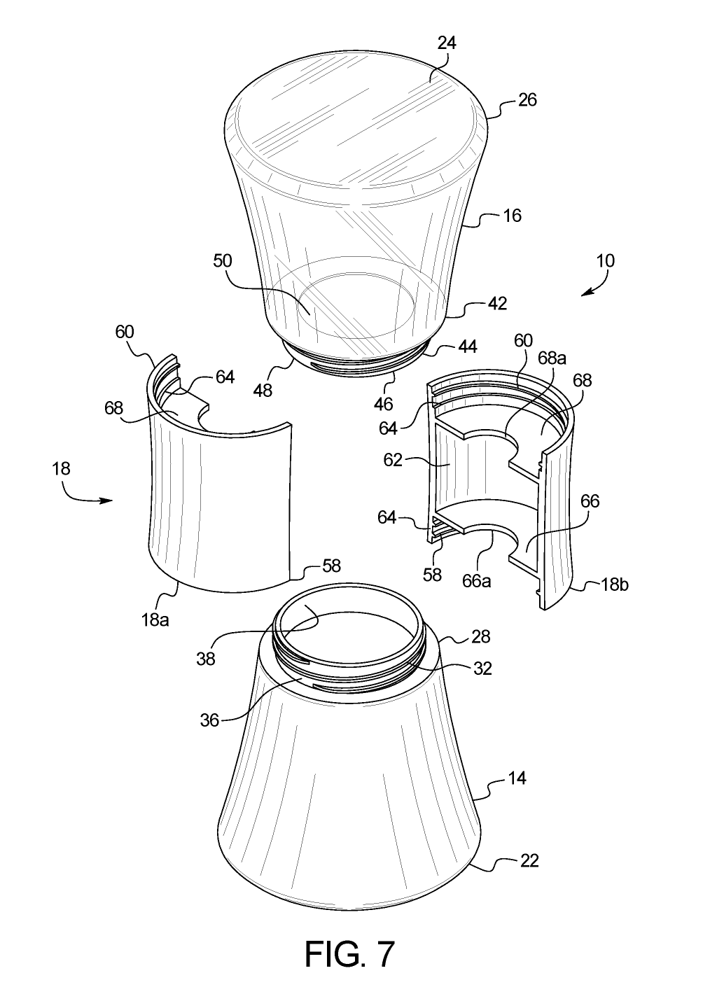

As shown in FIGS. 6 and 7, the first end portion 14 is preferably hollow so as to enable rigid or semi-rigid elements 30 to be placed therein. Moreover, the first end portion 14 preferably includes threads 32 at the second end 28 to enable the first end portion 14 to be detachably attached to the central portion 18. That is, the second end 28 of the first end portion 14 includes a protrusion 34 that includes threads 32 on an outer surface 36 thereof. The protrusion 34 is generally circular and defines an opening 38 in the first end portion 14. The opening 38 enables access into the hollow interior portion 40 of the first end portion 14.

Preferably, the second end portion 16 is made from a second material, such as plastic, glass or any other suitable material. Thus, in this embodiment, the first and second materials are different from each other. In this embodiment, the second end portion 16 is formed to be transparent or translucent to enable viewing through the second end portion 16. However, the first and second end portions 14 and 16 can be formed from the same or similar materials or in any suitable or desired manner. The second end portion 16 can be formed so as to be frusto-conical. In particular, the second end 26 of the second end portion 16 is generally circular such that the second end surface 24 is generally circular and flat. The diameter of the second end portion 16 decreases in a curved or arcuate manner to the first end 42 of the second end portion 16. The first end 42 of the second end portion 16 preferably has the smallest diameter of the second end portion 16. The first end 42 is generally circular. It is noted that the second end portion 16 can be formed in any desired manner and the structure described herein is merely exemplary.

The second end portion 16 is preferably hollow so as to enable the rigid or semi-rigid elements 30 to be placed therein. Moreover, the second end portion 16 preferably includes threads 44 at the first end 42 to enable the second end portion 16 to be detachably attached to the central portion 18. That is, the first end 42 of the second end portion 16 includes a protrusion 46 that includes threads 44 on an outer surface 48 thereof. The protrusion 46 is generally circular and defines an opening 50 in the second end portion 16. The opening 50 enables access into the hollow interior portion 52 of the second end portion 16.

The central portion 18 can be any suitable material such a metal, rubber or plastic. Moreover, the central portion 18 can be formed of one material (e.g., metal) and be covered or partially covered with a second material (rubber or plastic) to improve gripping. The central portion 18 is generally cylindrical, but can have first and second ends 52 and 54 that have a lightly larger diameter than the middle portion 46. In one embodiment, the first and second ends 52 and 54 have substantially the same diameter as the second end 28 of the first end portion and the first end 42 of the second end portion 16.

The central portion 18 can have internal threads 64 at the first and second ends 58 and 60 on an interior surface 62 to couple to the first and second end portions 14 and 16; however, it is noted that the central portion 18 does not necessarily need to connect to the first and second end portions 14 and 16 in this manner, and can be connected to these portions in any suitable manner. The central portion 18 can include first and second internal ribbed portions 66 and 68 that extend transversally to the longitudinal direction L of the training device 10. Each ribbed portion 66 and 68 includes an opening 66a and 68a that is configured to allow the plurality of rigid or semi-rigid elements 30 to pass from the central portion 18 to the first and second end portions 14 and 16.

In one embodiment, the central portion 18 is a two piece portion (first portion 18a and second portion 18b) that is divided along the longitudinal direction L. See FIG. 23. The central portion 18 can thus be fit around the ends of the first and second end portions 14 and 16. The first and second portions 18a and 18b of the central portion 18 can be coupled together in any suitable manner. The first and second portions 18a and 18b of the central portion 18 can be permanently, semi-permanently or removably attached to each other.

Preferably, at least one of the first and second end portions 14 and 16 is separable from the central portion 18, for example, by threading. However, these portions can be coupled together in any suitable manner, including snap fit, interference fit, a threaded fit or in any other manner. However, these portions can be permanently or semi-permanently coupled or bonded together, such that they cannot be separated without causing damage or destruction.

A plurality of rigid or semi rigid elements 30 can be disposed within the hollow tubular body 12. The elements 30 can be formed of any suitable material that would cause a first sound when struck against the first end portion 14 (e.g., metal) and a second (different) sound when struck against the second end portion 16 (e.g., plastic). That is, the plurality of rigid or semi rigid elements 30 are capable of being moved to into the first end portion 14 to strike the first material and cause a first (tonal) sound and moved into the second end portion 16 to strike the second material and cause a second (tonal) sound different from the first sound. The plurality of rigid or semi rigid elements 30 can be plastic or metal beads, coins, washers, bolts, or any other suitable element. The plurality of rigid or semi rigid elements 30 can be food items or treats, thus enabling the hollow tubular body 12 to act as a holder or container.

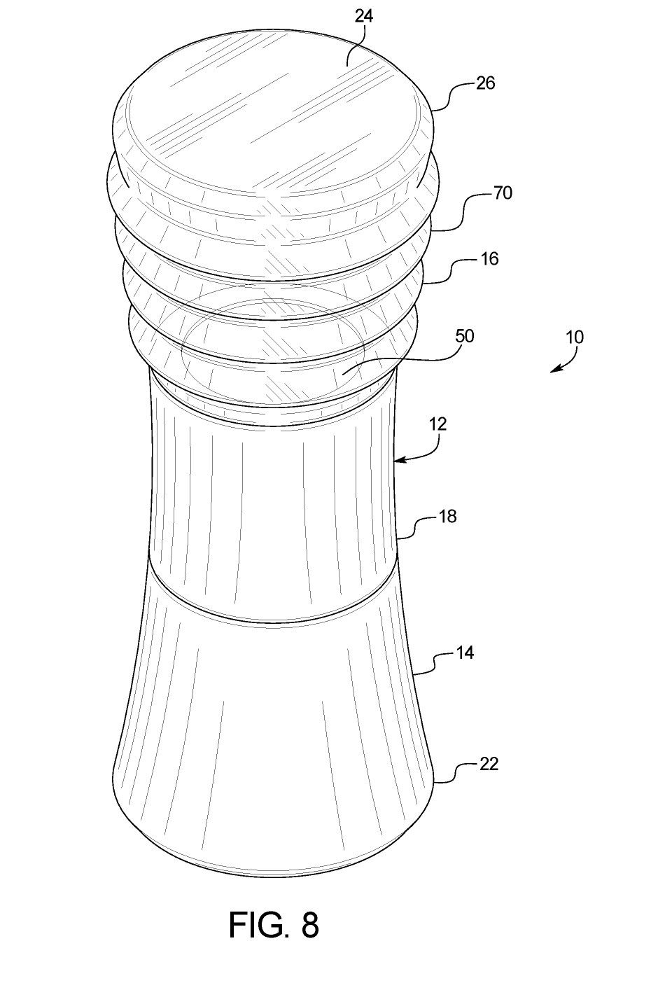

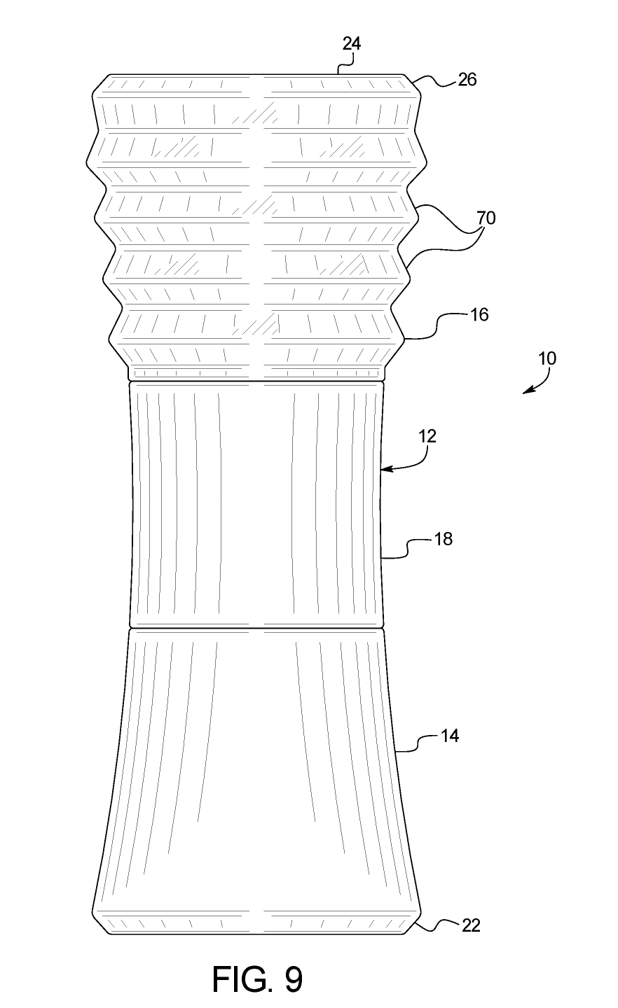

In one embodiment, one end (for example the second end portion 16) can have ridges 70 that extend circumferentially around the outer surface of the second end portion 16. See FIGS. 8 and 9. The ridges 30 can be external only (thus the second end portion could have a smooth internal surface) or have a commensurate internal shape. The ridges 70 can increase gripping and/or can change or enhance the noise in the second end portion 16. Please note that the remainder of the training device 10 is similar to as described above.

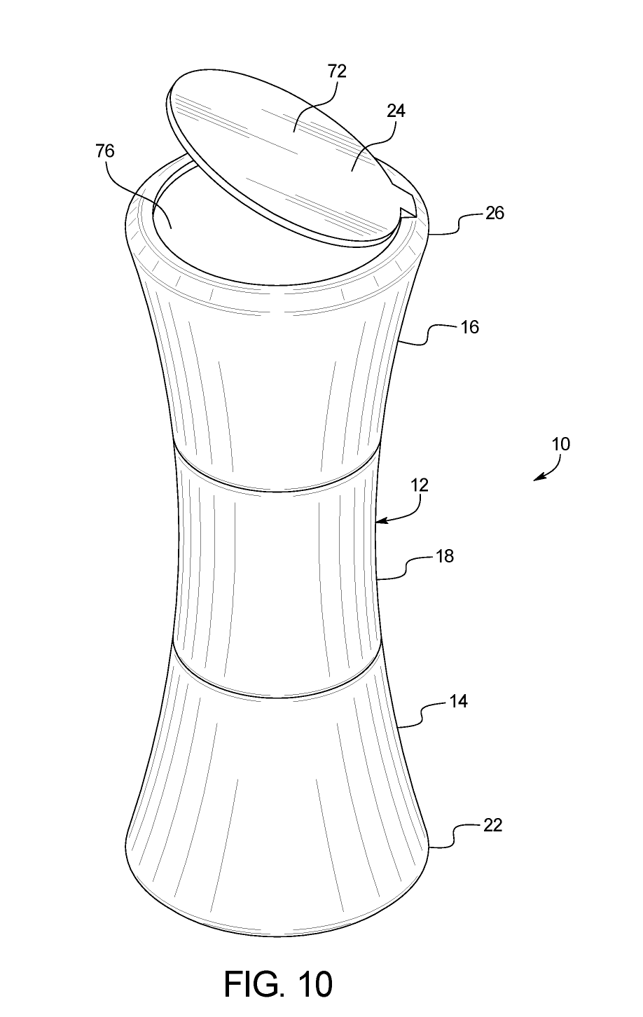

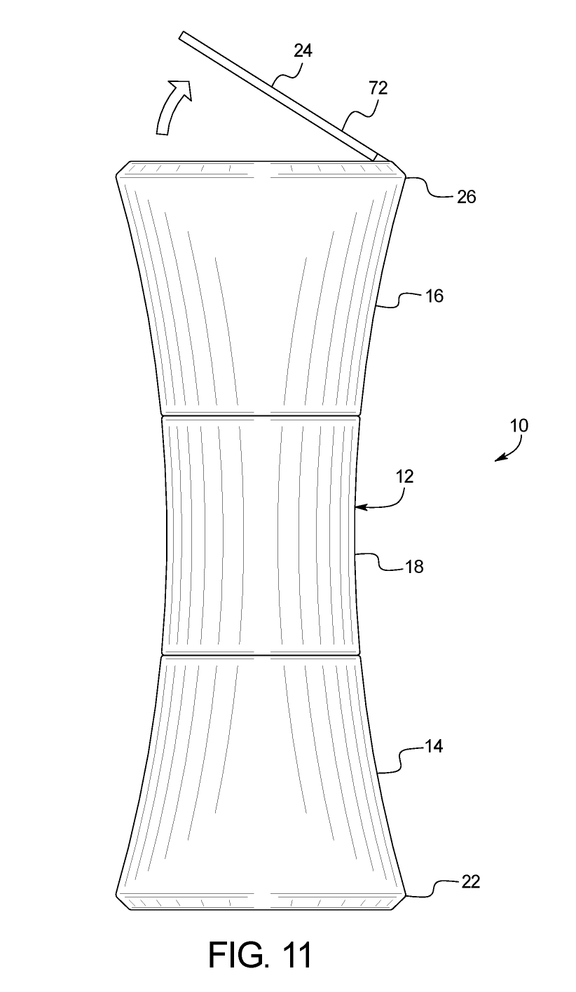

As shown in FIGS. 10 and 11, the second end portion 16 can be opaquae. Thus, contrary to the embodiment discussed above, the second end portion 16 is not transparent or translucent. In this embodiment, the second end portion 16 can be made from any suitable non-transparent/non-translucent material, such as metal, plastic, rubber or any other suitable material.

As shown in FIGS. 10 and 11, in one embodiment either or both of the first and second end portions 14 and 16 can include a lid 72. The lid can be hinged to the second end 26 of the second end portion 16 or can be completely removable. It is noted that the lid 72 can be attached to the respective portion (e.g., second end portion 16) in any manner desired. That is, the lid 72 can be snap fit, hinged or interference fit with the respective portion (e.g., second end portion 16). The lid 72 is removable or partially removeable to enable access through an opening 76 into the hollow interior portion 52 of the second end portion 16. Thus, a user can open the lid 72 an insert an object or objects (e.g., rigid or semi rigid elements 30) in the training device 10 and then close the lid 72.

Accordingly, the one or both of the first and second end portions 14 and 16 can portions can be separated from the central portion 18 or each other, the lid 72 can be opened and a plurality of rigid or semi rigid elements 30 can be inserted into the hollow interior portions 40 and 52 of at least one of the first and second portions or into at least one of the first end portion 14, the second end portion 16 and the central portion 18. The first and second portions or the first end portion 14, the second end portion 16 and the central portion 18 can then be coupled together. The user can then make a first sound by tilting the pet training device 10 is a direction so that the first end portion 14 is downward. The plurality of rigid or semi rigid elements 30 will fall due to gravity and strike the interior walls of the first end portion 14 making a first sound or tone. The striking of the first end portion 14 can be done to get a pet's attention or performed in an attempt to dissuade the pet from unwanted behavior.

In one embodiment, the hollow tubular body 12 can be formed in two separate portions. The first portion includes the first end portion 14 and a first portion of the central portion 18, and the second portion includes the second end portion 16 and a second portion of the central portion 18. The first portion, in this embodiment, can be separable from the second portion. These portions can be coupled together in any suitable manner, including snap fit, interference fit, a threaded fit or in any other manner. However, these portions can be permanently or semi-permanently coupled or bonded together, such that they cannot be separated without causing damage or destruction.

In one embodiment, the entire first and portion and a (first) portion of the central portion 18 (approximately half of the central portion 18) are formed of metal. In this embodiment, the first end portion 14 and the first portion of the central portion 18 are integral and formed as a one piece unit. For example, the first end portion 14 and the first portion of the central portion 18 can be molded as a monolithic one-piece member or in any other suitable manner. If desired, the first end portion 14 and the first portion of the central portion 18 can be formed as two separate elements that are bonded or connected together in any suitable manner.

As discussed herein, at least one of the first and second end portions 14 and 16 can be separated from the central portion 18. In another embodiment, the first and second portions can be separated from each other. In another embodiment, the hollow tubular body 12 can include a lid 72. In each of these embodiments, after separation or opening of the lid, each and some or all of the plurality of rigid or semi rigid elements 30 can be removed and replaced by another type of rigid or semi rigid element. Thus, the pet training device 10 is capable of making a variety of tones or sounds depending on the desire of the user.

In operation, the user can make a first sound by tilting the pet training device 10 is a direction so that the first end portion 16 is downward. The plurality of rigid or semi rigid elements 30 will fall due to gravity and strike the interior walls of the first end portion 16 making a first sound or tone, due to the specific material of the first end portion 16. The user can also make a second sound by tilting the pet training device 10 is a direction so that the second end portion 16 is downward. The plurality of rigid or semi rigid elements 30 will fall due to gravity pass through the opening 38 in the first end portion 14, through the openings 66a and 68a in the ribbed portions 66 and 68 of the central portion 18, and through the opening 50 in the second end portion 16. Along the way, the plurality of rigid or semi rigid elements 30 strike the ribbed portions 66 and 68 and the interior walls of the second end portion 16 and the central portion 18. When the plurality of rigid or semi rigid elements 30 strike the internal walls of the second end portion 16, they can make a second sound or tone, different from the first tone or sound, due to the specific material of the second end portion 16. Moreover, striking the various portions of the central portion 18 can make similar or different sounds to the first and/or second end portions 14 and 16. The striking of the first and/or second end portions 14 and 16 (and/or the central portion 18) can be done to get a pet's attention or performed in an attempt to dissuade the pet from unwanted behavior. Moreover, in some embodiments, the ridges 70 can alter or enhance the sound when the plurality of rigid or semi rigid elements 30 contact the interior portions thereof.

The embodiments of the present invention described herein form an effective pet training device can include different sounds that enable the pet handler to communicate different messages to the pet.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “portion” or “element” when used in the singular can have the dual meaning of a single part or a plurality of parts. Accordingly, these terms, as utilized to describe the present invention should be interpreted relative to a pet training device.

The terms of degree such as “generally” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A pet training device comprising:
a hollow tubular body, the hollow tubular body having a first end portion, a second end portion and central portion, the central portion having a diameter that is less than a diameter of both the first and second end portions, at least the first end portion is made from a first material, and at least the second end portion is made from a second material, the first and second materials being different from each other; and
a plurality of rigid or semi rigid elements disposed within the hollow tubular body and capable of being moved into the first end portion to strike the first material and cause a first sound and moved into the second end portion to strike the second material and cause a second sound different from the first sound.

2. The pet training device of claim 1, wherein
the first material is metal and the second material is plastic.

3. The pet training device of claim 1, wherein
the first end portion includes threads to connect to internal threads on the central portion.

4. The pet training device of claim 1, wherein
the second end portion is translucent.

5. The pet training device of claim 1, wherein
the second end portion includes ridges that extend circumferentially therearound.

6. The pet training device of claim 1, wherein
the central portion includes a plurality of internal ribs.

7. The pet training device of claim 6, wherein
the internal ribs define an opening to enable the plurality of rigid or semi rigid elements to pass through the central portion.

8. The pet training device of claim 1, wherein
the first and second end portion are generally frustoconical.

9. The pet training device of claim 1, wherein
the diameter of the first end portion is substantially the same as the diameter as the second portion.

10. The pet training device of claim 1, wherein
the second end portion includes a lid to enable access into an internal area thereof.

11. A pet training device comprising:
a hollow tubular body, the hollow tubular body having a first end portion and a second end portion and a central diameter that is less than a diameter of both the first and second end portions, at least the first end portion is made from a first material, and at least the second end portion is made from a second material, the first and second materials being different from each other; and
a plurality of rigid or semi rigid elements disposed within the hollow tubular body and capable of being moved into the first end portion to strike the first material and cause a first sound and moved into the second end portion to strike the second material and cause a second sound different from the first sound.

12. The pet training device of claim 11, wherein
the first material is metal and the second material is plastic.

13. The pet training device of claim 11, wherein
the first end portion includes threads.

14. The pet training device of claim 11, wherein
the second end portion is translucent.

15. The pet training device of claim 11, wherein
the second end portion includes ridges that extend circumferentially therearound.

16. The pet training device of claim 11, wherein
the first and second end portion are generally frustoconical.

17. The pet training device of claim 11, wherein
the diameter of the first end portion is substantially the same as the diameter as the second portion.

18. The pet training device of claim 11, wherein
the second end portion includes a lid to enable access into an internal area thereof.
